(19) United States
(12) Patent Application Publication
(10) Pub. No.: US 2020/0193764 A1
(43) Pub. Date: Jun. 18, 2020

(54) INSTANT GAMES BASED ON DISTRIBUTED LEDGER

(71) Applicant: Lottery Now, Inc., San Francisco, CA (US)

(72) Inventor: Gregory Ovalle, San Francisco, CA (US)

(21) Appl. No.: 16/218,415

(22) Filed: Dec. 12, 2018

(51) Int. Cl. G07F 17/32; G06Q 20/38; G06Q 20/40

(52) U.S. Cl. CPC G07F 17/329; G06Q 20/405; G06Q 20/382

(57) ABSTRACT

A method for creating an instant game is provided. The method receives from a game operator a request to create an instant game. The method records in a distributed ledger smart contract code of a smart contract. Under control of the smart contract code, the method: receives a prize table indicating prize amounts and prize frequency information for each prize amount; validates the prize table to ensure that all of the prize amounts are positive and unique; and when the prize table is valid, stores the prize table as a state of the smart contract, wherein the instant game is ready to be played.

### BACKGROUND

Lotteries are very popular games of chance that are played throughout the world. A lottery may be a draw lottery or an instant lottery. With a draw lottery, a player selects or is given numbers, and winning numbers are later drawn. With an instant lottery, a player is given a ticket with an outcome determined, but the player needs to take some action to reveal the outcome (e.g., scratch a portion of the ticket to reveal a $20 winning). Online versions of instant lottery games simulate this action on a computer. Instant lottery games may be based on a pay table, which may list prize amounts and the odds or percentages of winning them. For example, if the percentage of winning $1 million is 0.0001 percent, the percentage of winning $500,000 is 0.0002 percent, the percentage of winning $50 is 10 percent, and so on, then the pay table would have one entry mapping $1 million to 0.0001 percent, one entry mapping $500,000 to 0.0002 percent, one entry mapping $50 to 10 percent, and so on. The percentages of a pay table should add up to 100 percent. When a ticket is issued, a prize amount (e.g., $0) is selected based on the percentages of the pay table. Instant lottery games are popular because they allow players to immediately determine whether their tickets are winning tickets, as opposed to waiting for a draw.

Online Lottery games typically allow players to interact with gaming authorities over the Internet. For example, players may purchase tickets directly from the gaming authority via the Internet and select certain options, such as the numbers to play (referred to as a “drawline”) and the specific draw of the game to be played (e.g., a specific week for weekly draws). When a ticket is purchased, the gaming authority issues a lottery ticket to the player that includes the ticket drawline and records that that drawline was played. At the close of a draw, a winning drawline is drawn and publicized. Winning players may be able to collect small payouts from an establishment (e.g., store), referred to as a reseller, that sells tickets. If a payout is large (e.g., a jackpot), however, the winning player may be required to collect the payout from the gaming authority directly so that the identity of the player is known, the proper taxes can be withheld, taxing authorities can be notified, and so on. In addition to lotteries, many different games of chance can be played. Such games include, for example, raffles, Keno, poker, blackjack, roulette, slot machine games, and so on. Games of chance may also depend of external events such as outcome of sporting events (e.g., the FIFA World Cup, the World Series, “The Championships, Wimbledon,” and the Kentucky Derby), outcomes of political events (e.g., election of a president or prime minister, passage of a bill by the U.S. Congress), outcome of non-political voting events (e.g., Nobel Peace Prize, Oscar for Best Picture, election of Pope), security or commodity prices (e.g., price of bitcoin or crude oil, stock price of a company, closing price of NASDAQ or DAX), and so on.

Lotteries are typically operated as individual, separate, and distinct gaming operations. Each lottery has its own products, branding, advertising, and marketing. Lotteries that are paper-based typically employ terminals at reseller locations that are connected via dedicated communication links to a central server system that runs computer programs to manage the games of the lottery and store data of the lotteries. Each lottery needs to put teams in place to manage the software and hardware, the delivery of paper tickets, terminal and communication issues, and so on. Each lottery typically purchases the same infrastructure (e.g., hardware, software, and communications links) and pays for maintenance and customization individually.

Lotteries spend significant amounts of money on security. Because of the large sums wagered and paid out, lotteries face threats from both internal and external malicious actors who illegally manipulate wagers or results for their personal gain. To mitigate the effects of these threats, lotteries attempt to secure every aspect of their infrastructure using sophisticated and expensive security techniques such as issuing tickets on special paper ticket stock matched to specific resellers, employing dedicated networks from terminals to a central server system, employing multi-level, role-based security, and so on. Nevertheless, as external threats (e.g., cyberattacks) grow more sophisticated and internal threats more creative, lotteries find it difficult, time-consuming, expensive, and sometimes futile to counteract these threats.

There have been several well-publicized examples of frauds perpetrated by malicious internal actors on lotteries. In one example, the internal head of security of the Multi-State Lottery Association (“MUSL”) was the malicious actor who perpetrated a fraud against the U.S. Powerball lottery. MUSL serves lotteries in 33 states and provides the computer systems to generate the random numbers used for several games, including Powerball, Mega Millions, and Hot Lotto. This malicious actor accessed and manipulated the computer systems to select the winning numbers in the same computer system he was responsible for protecting and maintaining. This fraud continued undetected for years. In another example, the operator of the Northstar Lottery (i.e., the Illinois state lottery) purposefully did not award many of the largest prizes in the instant games of the lottery.

Distributed ledgers are currently being used in a wide variety of business applications. The bitcoin system is an example of a distributed ledger. The bitcoin system was developed to allow electronic cash to be transferred directly from one party to another without going through a financial institution, as described in the white paper entitled “Bitcoin: A Peer-to-Peer Electronic Cash System” by Satoshi Nakamoto. A bitcoin (e.g., an electronic coin) is represented by a chain of transactions that transfers ownership from one party to another party. To transfer ownership of a bitcoin, a new transaction is generated and added to a stack of transactions in a block. The new transaction, which includes the public key of the new owner, is digitally signed by the owner with the owner's private key to transfer ownership to the new owner, as represented by the new owner public key. The signing by the owner of the bitcoin is an authorization by the owner to transfer ownership of the bitcoin to the new owner via the new transaction. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

To ensure that a previous owner of a bitcoin did not double-spend the bitcoin (i.e., transfer ownership of the same bitcoin to two parties), the bitcoin system maintains a distributed ledger of transactions. With the distributed ledger, a ledger of all the transactions for a bitcoin is stored redundantly at multiple nodes (i.e., computers) of a blockchain network. The ledger at each node is stored as a blockchain. In a blockchain, the transactions are stored in the order that the transactions are received by the nodes. Each node in the blockchain network has a complete replica of the entire blockchain. The bitcoin system also implements techniques to ensure that each node will store the identical blockchain, even though nodes may receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The bitcoin system also implements techniques to ensure that it would be infeasible to change a transaction and regenerate the blockchain by employing a computationally expensive technique to generate a nonce that is added to the block when it is created. A bitcoin ledger is sometimes referred to as an Unspent Transaction Output (“UTXO”) set because it tracks the output of all transactions that have not yet been spent.

Although the bitcoin system has been very successful, it is limited to transactions in bitcoins or other cryptocurrencies. Blockchains have been developed to support transactions of any type, such as those relating to the sale of vehicles, sale of financial derivatives, sale of stock, payments on contracts, and so on. Such transactions use identity tokens to uniquely identify something that can be owned or can own other things. An identity token for a physical or digital asset is generated using a cryptographic one-way hash of information that uniquely identifies the asset. Tokens also have an owner that uses an additional public/private key pair. The owner public key or hash of the owner public key is set as the token owner identity, and when performing actions against tokens, ownership proof is established by providing a signature generated by the owner private key and validated against the public key or hash of the public key listed as the owner of the token. A person can be uniquely identified, for example, using a combination of a user name, social security number, and biometric (e.g., fingerprint). The creation of an identity token for an asset in a blockchain establishes provenance of the asset, and the identity token can be used in transactions (e.g., buying, selling, insuring) involving the asset stored in a blockchain, creating a full audit trail of the transactions.

To enable more complex transactions than bitcoin can support, some systems use “smart contracts.” A smart contract is a decentralized computer program that comprises code and a state. A smart contract can perform virtually any type of processing such as sending money, accessing external databases and services (e.g., oracles), and so on. A smart contract may be executed in a secure platform (e.g., Ethereum platform, which provides a virtual machine) that supports recording transactions in a blockchain. The smart contract code itself may be recorded as a transaction in the blockchain using an identity token that is a hash of the smart contract code so that it can be authenticated. When deployed, a constructor of the smart contract executes, initializing the smart contract and its state. In Ethereum, a smart contract is associated with a contract account. There are two types of accounts in Ethereum: externally owned accounts (“EOA”), which are controlled by private keys, and contract accounts, which are controlled by computer code. Accounts contain the following fields: a balance, code (if present), and a storage (empty by default). The code of a smart contract is stored as the code in a contract account, and the state of the smart contract is stored in the contract account's storage, which the code can read from and write to. An EOA has no code and does not need a storage, so those two fields are empty in an EOA. Accounts have a state. The state of an EOA comprises only a balance, whereas the state of a contract account comprises both a balance and a storage. The states of all accounts are the state of the Ethereum network, which is updated with every block and about which the network needs to reach a consensus. An EOA can send transactions to other accounts by signing the transactions with the private key of the EOA account. A transaction is a signed data package that contains a message to be sent from an EOA to the recipient account identified in the transaction. Like an EOA, a contract account, under control of its code, can also send messages to other accounts. However, a contract account can send messages only in response to transactions that it has received. Therefore, all action in the Ethereum blockchain is triggered by transactions sent from EOAs. A message sent by a contract account differs from a transaction sent by an EOA in that a message sent by a contract account does not include a cryptographic signature since a contract account is not controlled by a private key. When a contract account receives a message, every mining node that maintains a replica of the blockchain executes the code of the contract account as part of the block validation process. So if a transaction is added into a block, all nodes that validate the block executes the code whose execution is triggered by that transaction. Although the execution of the computer code at each node helps ensure the authenticity of the blockchain, it requires large amounts of computer resources to support such redundant execution of computer code.

Although blockchains can effectively store transactions, the large amount of computer resources, such as storage and computational power, needed to maintain all the replicas of the blockchain can be problematic. To overcome this problem, some systems for storing transactions do not use blockchains, but rather have each party to a transaction maintain its own copy of the transaction. One such system is the Corda system developed by R3, Ltd., which provides a decentralized distributed ledger platform in which each participant in the platform has a node (e.g., computer system) that maintains its portion of the distributed ledger. When parties agree on the terms of a transaction, a party submits the transaction to a notary, which is a trusted node, for notarization. The notary maintains an UTXO database of unspent transaction outputs. When a transaction is received, the notary checks the inputs to the transaction against the UTXO database to ensure that the outputs that the inputs reference have not been spent. If the inputs have not been spent, the notary updates the UTXO database to indicate that the referenced outputs have been spent, notarizes the transaction (e.g., by signing the transaction or a transaction identifier with a public key of the notary), and sends the notarization to the party that submitted the transaction for notarization. When the party receives the notarization, the party stores the notarization and provides the notarization to the counterparties.

### BRIEF DESCRIPTION OF THE DRAWINGS

FIG. 1 is a block diagram that illustrates the DLG system and systems that interact with the DLG system in some embodiments.

FIG. 2 is a flow diagram that illustrates the processing of a create game component of the DLG system in some embodiments.

FIG. 3 is a flow diagram that illustrates the processing of a receive prize table component of a smart contract of the DLG system in some embodiments.

FIG. 4 is a flow diagram that illustrates the processing of a validate prize table component of a smart contract of the DLG system in some embodiments.

FIG. 5 is a flow diagram that illustrates the processing of a receive game cards component of a smart contract of the DLG system in some embodiments.

FIG. 6 is a flow diagram that illustrates the processing of a validate game cards component of a smart contract of the DLG system in some embodiments.

FIG. 7 is a flow diagram that illustrates the processing of a play game component of a smart contract of the DLG system in some embodiments.

FIG. 8 is a sequence diagram that illustrates the creation of an instant game in some embodiments.

FIG. 9 is a sequence diagram that illustrates the playing of an instant game in some embodiments.

FIG. 10 is a diagram that illustrates an example blockchain and state transitions of the DLG system during the creation of an instant game in some embodiments.

FIG. 11 is a diagram that illustrates a state transition of the DLG system during the playing of an instant game in some embodiments.

### DETAILED DESCRIPTION

Methods and systems are provided for creating and playing instant games using smart contracts on a distributed ledger. In some embodiments, a distributed ledger gaming (“DLG”) system employs a smart contract for an instant game to control the creation and operation of the game in a secure and verifiable manner using the distributed ledger. Each different type of game may have a smart contract to support that game. For example, there may be a smart contract to support poker and a smart contract to support roulette. When the DLG system receives a request from a game operator to create an instant game, the DLG system initially records smart contract code of a smart contract in a blockchain, which is a type of distributed ledger. Even though an embodiment of the DLG system that employs a blockchain is described below, embodiments of the DLG system may employ any type of distributed ledger. Under control of the smart contract code, the smart contract receives a prize table associated with the game and verifies whether the prize table is valid. A prize table shows prize amounts and prize frequency information. A frequency indicates the odds or chances of winning a particular prize amount. A frequency may be expressed as a percentage or an absolute number. For example, a prize table may be a list of prize amounts and the percentages of winning them or an equivalent data structure such as a list of amount-count pairs, where the count represents the number of prizes to be awarded at that amount (e.g., $1M-1, $500K-2, $10-100,000, etc.). A prize table is valid if: (1) all of the prize amounts are positive and unique; and (2) where frequency information is expressed as percentages, all the percentages add up to 100 percent. When the prize table is valid, the smart contract stores it as a state of the smart contract, indicating that the game is created and ready to be played.

In some embodiments, in addition to receiving a prize table, the smart contract receives and validates a set of game cards. A game card for a poker instant game, for example, may show a dealer's hand and several player's hands with a matching prize. After scratching off all cards, if any of the player's hands beats the dealer's hand, the player wins the prize shown for that hand. A game card has a value or prize amount associated with it. A set of game cards is valid if the value for every card is in the prize table and if, for every entry in the prize table, the number or percentage of cards with that entry's value matches that entry's frequency. For example, consider the following prize table:

| Prize Amount | Frequency |
|---|---|
| $10 | 1% |
| $5 | 2% |
| $2 | 25% |
| $0 | 72% |

If there are 100 game cards, then there would have to be one card with a $10 value, two cards with a $5 value, twenty-five cards with a $2 value, and seventy-two cards with a $0 value. When the set of game cards is valid, the smart contract stores the game cards as a state of the smart contract.

After the creation of the game, the smart contract also controls the playing of the game. The smart contract has a state that includes a prize table, a count for each prize amount in the prize table, and a total count. The count for a prize amount indicates the number of times the prize amount has been played/awarded, and the total count indicates the total number of times the game is to be played. Under control of the smart contract code, the smart contract receives a place order message to play the game for a player. A place order message is sent from a purchase account from which the price of a game ticket is debited and includes a winnings account to which any prize amount is credited. A purchase account and a winnings account may be the same account. Upon receiving the place order message, the smart contract transfers the ticket price from the purchase account to an account of the game, which may be the smart contract account. If the transfer fails (e.g., there is not enough money in the purchase account), the smart contract returns an error. When the transfer succeeds, the smart contract randomly selects a prize amount from the prize table. The smart contract determines whether the selected prize amount is available by comparing the count for the selected prize amount to the frequency for that prize amount as provided in the prize table. When the frequency is in percentage, for example, if the count for the selected prize amount is equal to the total count times the percentage for that prize amount, the smart contract determines that the selected prize amount is not available. When the selected prize amount is not available, the smart contract repeatedly selects another prize amount in the prize table until an available prize amount is found. When the smart contract finds an available prize amount, the smart contract transfers the selected prize amount to the winnings account, increments the count for the selected prize amount to update the number of times it has been played/awarded, and notifies the player. For example, consider an instant game with a total count equal to 100 and the following prize table, along with a count for each prize amount:

| Prize Amount | Frequency | Count |
|---|---|---|
| $10 | 1% | 0 |
| $5 | 2% | 1 |
| $2 | 25% | 25 |
| $0 | 72% | 50 |

Suppose, when the smart contract for the game receives a place order message from a player, the smart contract randomly selects the $5 prize amount. Since the count for the $5 prize amount indicates that it has been played/awarded only once, which is less than the frequency for that prize amount, the smart contract transfers $5 to the player's winnings account, increments the count for the $5 prize amount to two, and notifies the player. Now suppose that the smart contract receives another place order message from another player and that the smart contract randomly selects the $5 prize amount again. This time, however, the $5 prize amount is not available because the count for the $5 prize amount is two, which is not less than the frequency for that prize amount. As such, the smart contract selects the next prize amount in the prize table, which is $2. But the $2 prize amount is not available either because the count for the $2 prize amount (25) is already equal to the frequency for that prize amount. Then the smart contract selects the next prize amount, which is $0. The $0 prize amount is available because the count for the $0 prize amount (50) is less than the frequency for that prize amount. Since the selected prize amount is $0, the smart contract does not transfer any money to the player's winnings account and increments the count for the $0 prize amount to fifty-one. Had the $0 prize amount also been unavailable, the smart contract would have rolled over to the beginning of the prize table and selected the first prize amount ($10) in the prize table.

In some embodiments, the state of the smart contract may include pre-generated game cards received from a game operator. When the smart contract receives a place order message from a player to play the game, the smart contract selects a random index ranging from one to the total number of game cards. The smart contract repeatedly increments the index until an unmarked/unplayed game card is found. When an unmarked game card is found, the smart contract marks the game card with the address of the winnings account and moves the value of the game card to the winnings account if there is any value. Then the smart contract returns the game card data to the player.

In some embodiments, the smart contract may generate game cards dynamically as it receives place order messages. For a poker instant game, for example, if the total number of game cards to be generated is 10,000, then the smart contract may select a random number ranging from one to 10,000, select a prize amount using that number and the prize table, and generate a game card with the selected prize amount and an image of a poker hand (e.g., straight flush).

In some embodiments, the smart contract uses an oracle to randomly select a game card or a prize amount. An oracle is a third-party service that provides external data to smart contracts in a secure and trusted manner (e.g., Oraclize). The smart contract uses an oracle to obtain a random number from a trusted external source of randomness (e.g., Random.org) and uses the number to select a game card or a prize amount. If there are 100 game cards, for example, the smart contract requests an oracle to provide a random index ranging from one to 100 and selects the game card at that index. If there are no game cards (not all instant games require game cards), the smart contract requests an oracle to provide a random number ranging from one to the total count and uses the number to select a prize amount based on the prize table. In the above example, number 1 may be mapped to the $10 prize amount; numbers 2 and 3 may be mapped to the $5 prize amount; numbers 4-28 may be mapped to the $2 prize amount; and numbers 29-100 may be mapped to the $0 prize amount. So, if the number provided by the oracle is 10, the smart contract selects the $2 prize amount. To ensure that all nodes executing the smart contract code use the same random number for a transaction, an oracle queries the external data source only once to get a random number and stores the number in the blockchain to be used by all nodes executing the smart contract code for that transaction.

In some embodiments, commit-reveal schemes may be used to generate random numbers. With a commit-reveal scheme, a player selects a seed and a nonce, encrypts them with the player's private key, and sends the encrypted seed and nonce to the operator of the game. The operator similarly selects a seed and a nonce, encrypts them with the operator's private key, and sends the encrypted seed and nonce to the player. The encrypted seeds and nonces are recorded as a transaction in the blockchain (e.g., via a smart contract). The parties then exchange the unencrypted seeds and nonces that are also recorded in the blockchain. A smart contract uses the public keys of the player and the operator to decrypt the encrypted seeds and nonces and verifies that they match the unencrypted seeds and nonces. The smart contract then combines the player's seed with the operator's seed and uses the combination as a seed to generate a random number for the game. The smart contract records the random number in the blockchain and sends the random number to the player and the operator. Then the parties can verify the random number by using each other's public key to decrypt each other's seed and nonce, combining the seeds, and using the combined seeds as a seed for the random number generator.

In some embodiments, a smart contract may be used to generate a random number on-chain that is mathematically correct and tamper-proof by using metadata and inputs from multiple actors. An example of this kind of approach is RANDAO, which is a distributed autonomous organization for creating a random number. Although slower and more expensive than some of the alternatives, RANDAO is a robust approach for generating a random number.

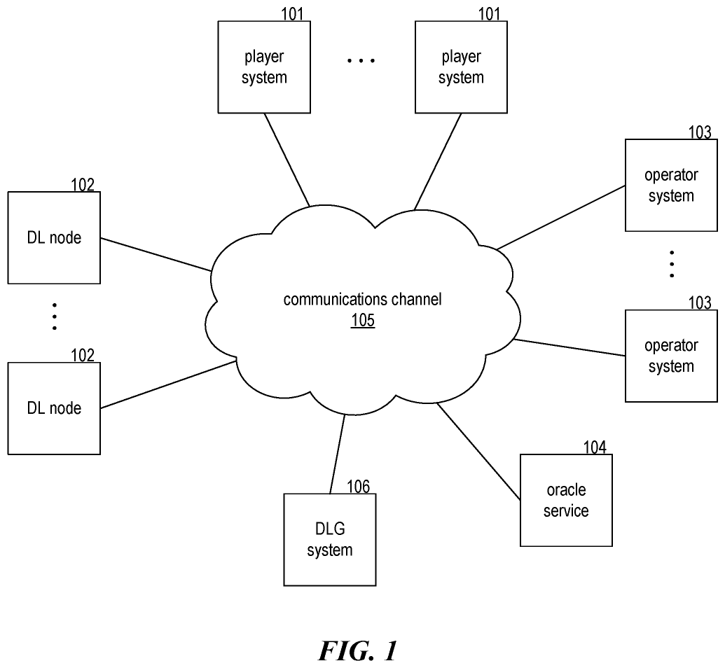

FIG. 1 is a block diagram that illustrates the DLG system and systems that interact with the DLG system in some embodiments. The DLG system 106 interacts with player systems 101, distributed ledger nodes 102, operator systems 103, and an oracle service 104 via communications channel 105. The DLG system controls the creation and overall playing of a game, including recording smart contract code in the blockchain, receiving game creation requests from operator systems, receiving ticket orders from player systems, transferring money between accounts, notifying players, and so forth. The operator system provides services to an operator or gaming authority of a game. The player systems allow players to interact with the DLG system to play games. The distributed ledger nodes each implement a copy of the blockchain, which includes transactions between accounts. The oracle service receives requests from smart contracts to provide random numbers and sends random numbers to the smart contracts as requested. The oracle service obtains random numbers from a trusted external source of randomness (e.g., Random.org).

The computing systems (e.g., network nodes or collections of network nodes) on which the DLG system may be implemented may include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on them or may be encoded with computer-executable instructions or logic that implements the DLG system. The data transmission media are used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys.

The DLG system may be described in the general context of computer-executable instructions, such as program modules and components, executed by one or more computers, processors, or other devices. Generally, program modules or components include routines, programs, objects, data structures, and so on that perform tasks or implement data types of the DLG system. Typically, the functionality of the program modules may be combined or distributed as desired in various examples. Aspects of the DLG system may be implemented in hardware using, for example, an application-specific integrated circuit (“ASIC”) or field programmable gate array (“FPGA”).

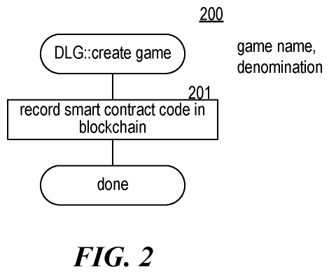

FIG. 2 is a flow diagram that illustrates the processing of a create game component of the DLG system in some embodiments. The create game component 200 is invoked when a game operator sends to the DLG system a request to create an instant game with a game name and a denomination. A denomination is the face value of an instant game ticket. For example, instant game tickets may be available in denominations of $1, $2, $5, $10, and $20. In block 201, the component records smart contract code for the game in the blockchain and then completes.

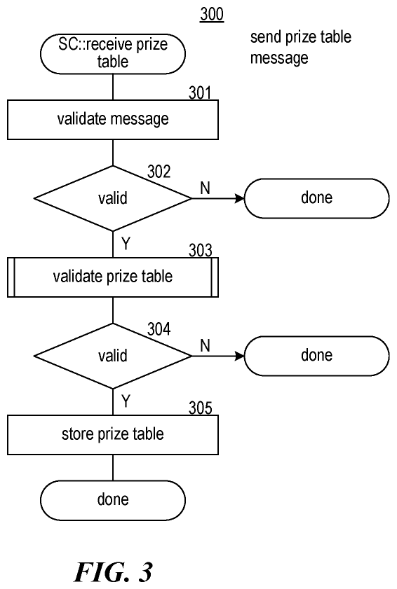

FIG. 3 is a flow diagram that illustrates the processing of a receive prize table component of a smart contract of the DLG system in some embodiments. The receive prize table component 300 is invoked when the smart contract receives a send prize table message from the game operator. In block 301, the component validates the message to ensure that the message is from the game operator by checking the message's signature. In decision block 302, if the message is valid, the component continues at block 303, else the component completes. In block 303, the component verifies whether the prize table is valid by invoking a validate prize table component. In decision block 304, if the prize table is valid, the component continues at block 305, else the component completes. In block 305, the component stores the prize table as a state of the smart contract and then completes.

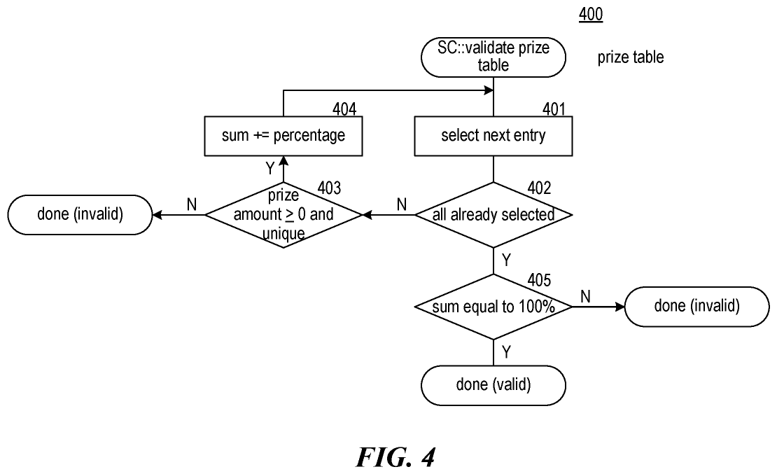

FIG. 4 is a flow diagram that illustrates the processing of a validate prize table component of a smart contract of the DLG system in some embodiments. The validate prize table component 400 validates a prize table to ensure that all of the prize amounts are positive and unique and that, where frequency information is expressed as percentages, all the percentages add up to 100 percent. In blocks 401-404, the component loops checking the validity of each entry in the prize table. In block 401, the component selects the next entry in the prize table. In decision block 402, if all the entries have already been selected, the component continues at block 405, else the component continues at block 403. In decision block 403, if the prize amount of the selected entry is positive and unique (i.e., has not been in another selected entry), the component continues at block 404, else the component completes and indicates that the prize table is invalid. In block 404, the component calculates the running sum of percentages of all the selected entries and loops to block 401 to select the next entry. In decision block 405, if the sum equals 100%, the component completes and indicates that the prize table is valid, else the component completes and indicates that the prize table is invalid.

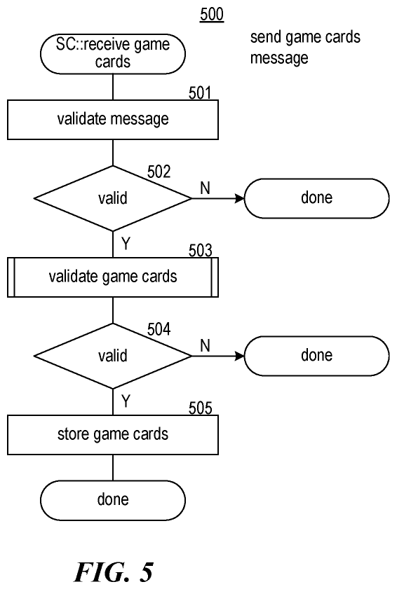

FIG. 5 is a flow diagram that illustrates the processing of a receive game cards component of a smart contract of the DLG system in some embodiments. The receive game cards component 500 is invoked when the smart contract receives a send game cards message from the game operator. In block 501, the component validates the message to ensure that the message is from the game operator by checking the message's signature. In decision block 502, if the message is valid, the component continues at block 503, else the component completes. In block 503, the component verifies whether the game cards are valid by invoking a validate game cards component. In decision block 504, if the game cards are valid, the component continues at block 505, else the component completes. In block 505, the component stores the game cards as a state of the smart contract and then completes.

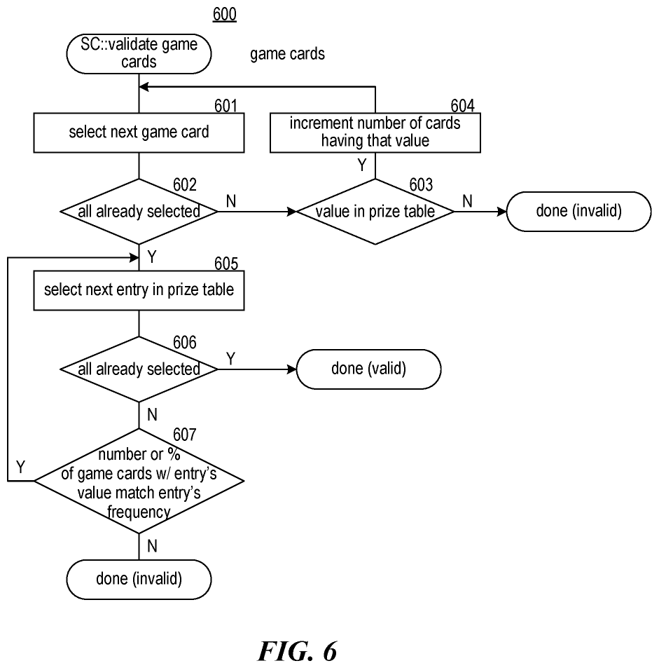

FIG. 6 is a flow diagram that illustrates the processing of a validate game cards component of a smart contract of the DLG system in some embodiments. The validate game cards component 600 validates a set of game cards to ensure that the value for every game card is in the prize table and that, for every entry in the prize table, the number or percentage of game cards with that entry's value matches that entry's frequency. In blocks 601-604, the component loops verifying whether each game card's value is in the prize table and keeping track of the number of game cards having that value. In block 601, the component selects the next game card. In decision block 602, if all the game cards have already been selected, the component continues at block 605, else the component continues at block 603. In decision block 603, if the selected game card's value is in the prize table, the component continues at block 604, else the component completes and indicates that the set of game cards is invalid. In block 604, the component increments the number of game cards having that value and loops to block 601 to select the next game card. In blocks 605-607, the component loops verifying whether, for every entry in the prize table, the number or percentage of game cards with the selected entry's value matches that entry's frequency. In block 605, the component selects the next entry in the prize table. In decision block 606, if all the entries have already been selected, the component completes and indicates that the set of game cards is valid, else the component continues at block 607. In decision block 607, if the number or percentage of game cards with the selected entry's value matches that entry's frequency, the component loops to block 605 to select the next entry in the prize table, else the component completes and indicates that the set of game cards is invalid.

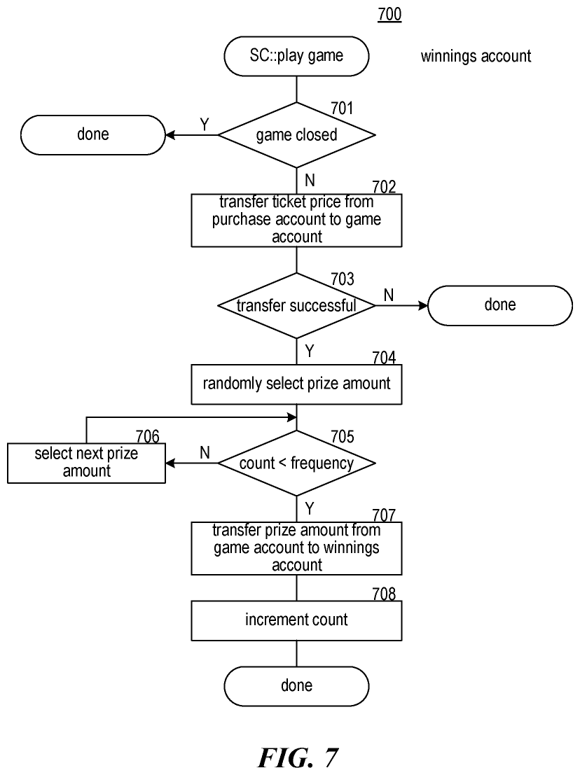

FIG. 7 is a flow diagram that illustrates the processing of a play game component of a smart contract of the DLG system in some embodiments. The play game component 700 is invoked when a player sends from a purchase account to the smart contract a place order message with a winnings account. In decision block 701, if the game has closed, the component completes, else the component continues at block 702. A game closes, for example, if all the game cards have been played or if the number of times the game has been played equals the total count. In block 702, the component transfers the ticket price from the purchase account to an account of the game, which may be the smart contract account. In decision block 703, if the transfer is successful, the component continues at block 704, else the component completes. The transfer may fail, for example, if there is not enough money in the purchase account. In block 704, the component randomly selects a prize amount from the prize table. This may be done using an oracle service to obtain a random number from a trusted external source of randomness such as Random.org, whose source of entropy is climate data. In decision block 705, if the count for the selected prize amount (the number of times the selected prize amount has been played/awarded) is less than the frequency for the selected prize amount, the component continues at block 707, else the component loops to block 706 to select the next prize amount. In block 707, the component transfers the selected prize amount from the account of the game to the winnings account. In block 708, the component increments the count for the selected prize amount to update the number of times it has been played/awarded. The component then completes.

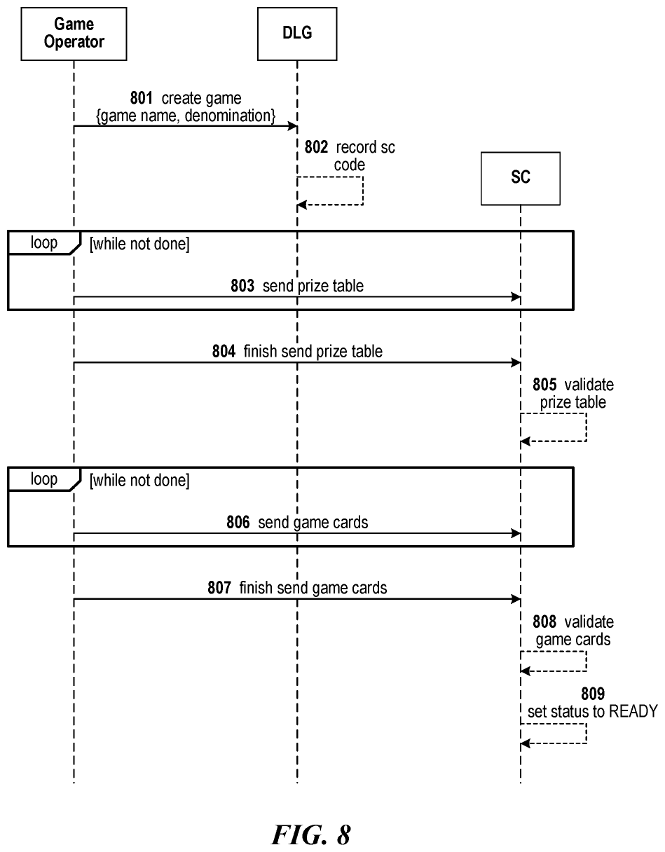

FIG. 8 is a sequence diagram that illustrates the creation of an instant game in some embodiments. A game operator sends 801 a request to create an instant game with a game name and a denomination. In response to the request, the DLG system records 802 smart contract code for the game in the blockchain. The game operator sends 803 a prize table to the smart contract, which may take multiple messages to the smart contract. When the game operator finishes 804 sending the prize table, the smart contract validates 805 the prize table. Then the game operator sends 806 game cards to the smart contract, which may take multiple messages to the smart contract. When the game operator finishes 807 sending the game cards, the smart contract validates 808 the game cards. When both the prize table and the game cards are valid, the smart contract sets 809 the game status to ready.

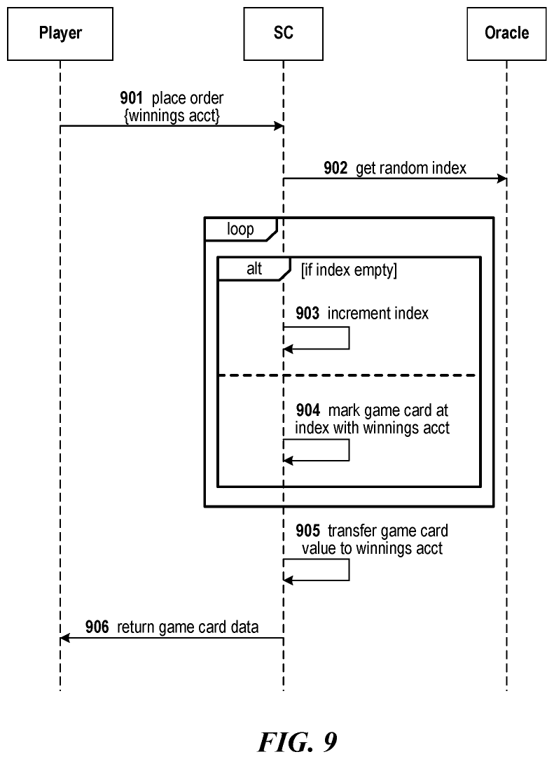

FIG. 9 is a sequence diagram that illustrates the playing of an instant game in some embodiments. A player sends 901 to the smart contract a place order message with a winnings account. In response, the smart contract sends 902 a request to the oracle to get a random index. The smart contract repeatedly increments 903 the index until an unmarked game card is found. When an unmarked game card is found, the smart contract marks 904 the game card at that index with the address of the winnings account. Then the smart contract transfers 905 the value of the game card to the winnings account and returns 906 the game card data to the player.

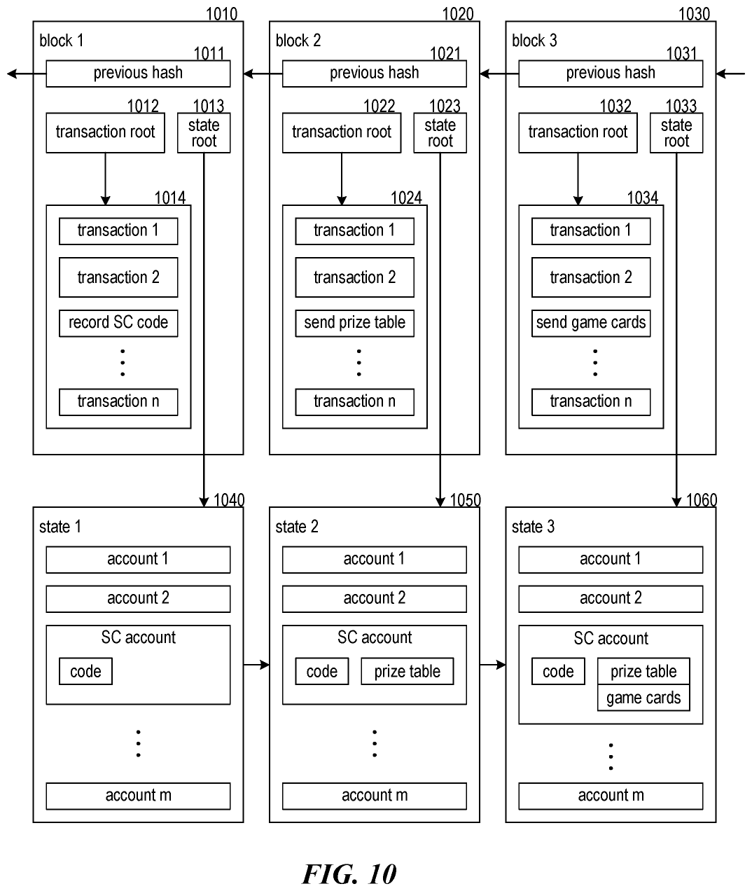

FIG. 10 is a diagram that illustrates an example blockchain and state transitions of the DLG system during the creation of an instant game in some embodiments. Blocks 1010-1030 may contain a previous hash 1011-1031, which points to the previous block, a transaction root 1012-1032, which points to a list of transactions 1014-1034, and a state root, which points to the most recent state 1040-1060 of the DLG system after executing all transactions in the previous blocks starting from the genesis block going up to and including that block itself. The state of the DLG system comprises the states of all accounts in the DLG system network and changes every time there is a transfer of value and information between accounts. Block 1 1010 contains a transaction that records smart contract code in the blockchain. As a result, a smart contract account is created, which is reflected in state 1 1040. A contract account may have code and storage. The code is executed every time the contract account receives a message, wherein the code can read from and write to the storage. Block 2 1020 contains a transaction that sends a prize table to the smart contract account. This transaction causes the smart contract code to be executed placing the prize table in the smart contract account's storage and modifying the state of the smart contract account to include the prize table as indicated by state 2 1050. Block 3 1030 contains a transaction that sends game cards to the smart contract account. After the smart contract code is executed, the resulting state 1060 indicates that the game cards are stored in the smart contract account's storage.

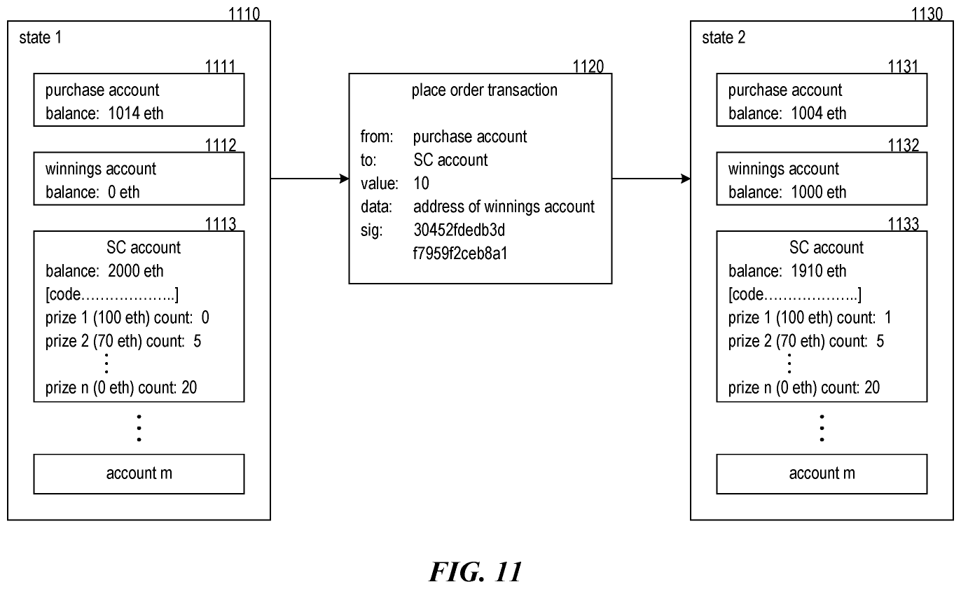

FIG. 11 is a diagram that illustrates a state transition of the DLG system during the playing of an instant game in some embodiments. The state of the DLG system comprises the states of all accounts in the DLG system network, and a state transition represents a transfer of value and information between accounts. State 1 1110 includes the states of a purchase account 1111, a winnings account 1112, and a smart contract account 1113. The state of each account includes an account balance. In addition to the account balance, the state of the smart contract account includes a count for each prize amount. A place order transaction 1120 sends 10 ethers (ticket price) from the purchase account to the smart contract account. The transaction is signed with the private key of the purchase account and includes the address of the winnings account as input data. This transaction triggers the execution of the smart contract code causing the following state changes in the accounts as indicated by state 2 1130: 1) the balance of the purchase account is decreased by 10 from 1014 to 1004 since the ticket price (10) was debited from the purchase account; 2) the balance of the winnings account is increased by the prize amount (100) from 0 to 100; 3) the balance of the smart contract account is decreased by 90 from 2000 to 1910 since the ticket price (10) was credited to the account and then the prize amount (100) was debited from the account; and 4) the count for prize 1 is increased from 0 to 1 to update the number of times the prize has been awarded.

The following paragraphs describe various embodiments of aspects of the DLG system. An implementation of the DLG system may employ any combination of the embodiments. The processing described below may be performed by a computing system with a processor that executes computer-executable instructions stored on a computer-readable storage medium that implements the DLG system.

In some embodiments, a method performed by one or more computing systems for creating an instant game is provided. The method receives from a game operator a request to create an instant game. The method records in a distributed ledger smart contract code of a smart contract. Under control of the smart contract code, the method: receives a prize table indicating prize amounts and prize frequency information for each prize amount; validates the prize table to ensure that all of the prize amounts are positive and unique; and when the prize table is valid, stores the prize table as a state of the smart contract, wherein the instant game is ready to be played. In some embodiments, the game creation request includes a game name and a denomination. In some embodiments, the prize frequency information for a prize amount is expressed as a percentage of winning that amount. In some embodiments, the prize frequency information for a prize amount is expressed as a number of prizes to be awarded at that amount. In some embodiments, under control of the smart contract code, the method: receives a set of game cards that have a value; and validates the set of game cards to ensure that the value for every game card is in the prize table and that, for every entry in the prize table, the percentage of game cards with that entry's value matches that entry's frequency. In some embodiments, when the set of game cards is valid, the method stores the set of game cards as a state of the smart contract.

In some embodiments, a method performed by one or more computing systems for playing an instant game is provided. Under control of smart contract code of a smart contract having a state that includes a prize table and a count for each prize amount in the prize table, wherein the prize table includes prize amounts and prize frequency information for each prize amount and the count for a prize amount indicates the number of times the prize amount has been awarded, the method: receives from a purchase account a place order message with a winnings account; transfers a game ticket price from the purchase account to an account of the instant game; selects a prize amount that is available as indicated by the count for the prize amount and the prize frequency information for the prize amount; modifies the state of the smart contract to increment the count for the selected prize amount; and transfers the selected prize amount from the account of the instant game to the winnings account. In some embodiments, the purchase account and the winnings account are the same account. In some embodiments, the account of the instant game is a contract account that includes the smart contract code. In some embodiments, under control of the smart contract code, the method dynamically generates a game card with the selected prize amount and returning the game card to the player. In some embodiments, the state of the smart contract includes a set of game cards. In some embodiments, the selecting of a prize amount includes obtaining from an oracle service a random index ranging from one to the total number of game cards and selecting the game card at that index. In some embodiments, the method marks the selected game card with an address of the winnings account. In some embodiments, the state of the smart contract includes a total count indicating the total number of times the instant game can be played. In some embodiments, the selecting of a prize amount includes obtaining from an oracle service a random number ranging from one to the total count and mapping the random number to a prize amount based on the prize frequency information.

In some embodiments, one or more computing systems for managing creation of an instant game are provided that comprise one or more computer-readable storage mediums storing computer-executable instructions and one or more processors for executing the computer-executable instructions stored in the one or more computer-readable storage mediums. The instructions receive from a game operator a request to create the instant game. The instructions record in a distributed ledger smart contract code of a smart contract. Under control of the smart contract code, the instructions: receive a prize table indicating prize amounts and prize frequency information; validate the prize table to ensure that all of the prize amounts are positive and unique; and when the prize table is valid, store the prize table as a state of the smart contract, wherein the instant game is ready to be played. In some embodiments, there is a smart contract for each different type of instant game.

In some embodiments, one or more computing systems for managing playing of an instant game are provided that comprise one or more computer-readable storage mediums storing computer-executable instructions and one or more processors for executing the computer-executable instructions stored in the one or more computer-readable storage mediums. Under control of smart contract code of a smart contract having a state that includes a prize table and a count for each prize amount in the prize table, wherein the prize table includes prize amounts and prize frequency information for each prize amount and the count for a prize amount indicates the number of times the prize amount has been awarded, the instructions: receive from a purchase account a place order message with a winnings account; transfer a game ticket price from the purchase account to an account of the instant game; select a prize amount that is available as indicated by the count for the prize amount and the prize frequency information for the prize amount; modify the state of the smart contract to increment the count for the selected prize amount; and transfer the selected prize amount from the account of the instant game to the winnings account. In some embodiments, the instructions use a commit-reveal scheme to generate a random number to select the prize amount. In some embodiments, the instructions use a distributed autonomous organization to generate a random number to select the prize amount.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by one or more computing systems for creating an instant game, the method comprising:
receiving from a game operator a request to create an instant game;
recording in a distributed ledger smart contract code of a smart contract; and
under control of the smart contract code:
receiving a prize table indicating prize amounts and prize frequency information for each prize amount;
validating the prize table to ensure that all of the prize amounts are positive and unique; and
when the prize table is valid, storing the prize table as a state of the smart contract, wherein the instant game is ready to be played.

2. The method of claim 1 wherein the game creation request includes a game name and a denomination.

3. The method of claim 1 wherein the prize frequency information for a prize amount is expressed as a percentage of winning that amount.

4. The method of claim 1 wherein the prize frequency information for a prize amount is expressed as a number of prizes to be awarded at that amount.

5. The method of claim 1 further comprising, under control of the smart contract code, receiving a set of game cards that have a value and validating the set of game cards to ensure that the value for every game card is in the prize table and that, for every entry in the prize table, the percentage of game cards with that entry's value matches that entry's frequency.

6. The method of claim 5 further comprising, when the set of game cards is valid, storing the set of game cards as a state of the smart contract.

7. A method performed by one or more computing systems for playing an instant game, the method comprising:
under control of smart contract code of a smart contract having a state that includes a prize table and a count for each prize amount in the prize table, wherein the prize table includes prize amounts and prize frequency information for each prize amount and the count for a prize amount indicates the number of times the prize amount has been awarded:
receiving from a purchase account a place order message with a winnings account;
transferring a game ticket price from the purchase account to an account of the instant game;
selecting a prize amount that is available as indicated by the count for the prize amount and the prize frequency information for the prize amount;
modifying the state of the smart contract to increment the count for the selected prize amount; and
transferring the selected prize amount from the account of the instant game to the winnings account.

8. The method of claim 7 wherein the purchase account and the winnings account are the same account.

9. The method of claim 7 wherein the account of the instant game is a contract account that includes the smart contract code.

10. The method of claim 7 further comprising, under control of the smart contract code, dynamically generating a game card with the selected prize amount and returning the game card to the player.

11. The method of claim 7 wherein the state of the smart contract includes a set of game cards.

12. The method of claim 11 wherein the selecting of a prize amount includes obtaining from an oracle service a random index ranging from one to the total number of game cards and selecting the game card at that index.

13. The method of claim 12 further comprising marking the selected game card with an address of the winnings account.

14. The method of claim 7 wherein the state of the smart contract includes a total count indicating the total number of times the instant game can be played.

15. The method of claim 14 wherein the selecting of a prize amount includes obtaining from an oracle service a random number ranging from one to the total count and mapping the random number to a prize amount based on the prize frequency information.

16. One or more computing systems for managing creation of an instant game, the one or more computing systems comprising:
one or more computer-readable storage mediums storing computer-executable instructions that receive from a game operator a request to create the instant game;
one or more computer-readable storage mediums storing computer-executable instructions that record in a distributed ledger smart contract code of a smart contract; and
one or more computer-readable storage mediums storing computer-executable instructions that under control of the smart contract code:
receive a prize table indicating prize amounts and prize frequency information;
validate the prize table to ensure that all of the prize amounts are positive and unique; and
when the prize table is valid, store the prize table as a state of the smart contract, wherein the instant game is ready to be played; and
one or more processors for executing the computer-executable instructions stored in the one or more computer-readable storage mediums.

17. The one or more computing systems of claim 16 wherein there is a smart contract for each different type of instant game.

18. One or more computing systems for managing playing of an instant game, the one or more computing systems comprising:
one or more computer-readable storage mediums storing computer-executable instructions that under control of smart contract code of a smart contract having a state that includes a prize table and a count for each prize amount in the prize table, wherein the prize table includes prize amounts and prize frequency information for each prize amount and the count for a prize amount indicates the number of times the prize amount has been awarded:
receive from a purchase account a place order message with a winnings account;
transfer a game ticket price from the purchase account to an account of the instant game;
select a prize amount that is available as indicated by the count for the prize amount and the prize frequency information for the prize amount;
modify the state of the smart contract to increment the count for the selected prize amount; and
transfer the selected prize amount from the account of the instant game to the winnings account; and
one or more processors for executing the computer-executable instructions stored in the one or more computer-readable storage mediums.

19. The one or more computing systems of claim 18 wherein the computer-executable instructions further include instructions that use a commit-reveal scheme to generate a random number to select the prize amount.

20. The one or more computing systems of claim 18 wherein the computer-executable instructions further include instructions that use a distributed autonomous organization to generate a random number to select the prize amount.
